(19) United States
(12) Patent Application Publication
(10) Pub. No.: US 2007/0289511 A1
(43) Pub. Date: Dec. 20, 2007

(54) Liquid fertilizer injection method, system, and apparatus

(76) Inventors: Ying Chen, WINNIPEG (CA); Erron James Leafloor, WINNIPEG (CA)

Correspondence Address: David G. Duckworth;Drummond & Duckworth, 4590 MacArthur Boulevard, Suite 500, Newport Beach, CA, 92660, US

(21) Appl. No.: 11/578,653

(22) PCT Filed: Apr. 14, 2005
(86) PCT No.: PCT/CA05/00560

§ 371 Date: Jul. 26, 2007

Related U.S. Application Data
(60) Provisional application No. 60/561,916, filed on Apr. 14, 2004.

(51) Int. Cl. A01G 25/09

(52) U.S. Cl. 111/92; 239/159; 239/172

(57) ABSTRACT

A method is described for cutting sub-surface cavities into a region of soil and for delivering liquid fertilizer directly to each cavity while minimizing overflow or spillage of liquid fertilizer onto the surrounding surface soil. A cutting apparatus is described for creating sub-surface cavities the soil, each cavity is associated with an opening at the soil surface through which liquid fertilizer can be delivered to the cavity. A system for delivery of liquid fertilizer to the cavities is described, which includes a fertilizer dispenser including a metering valve assembly for delivery of liquid fertilizer to each cavity. A synchronization system may be incorporated into the system for locating each cavity and directing the dispensing of liquid fertilizer.

### RELATED APPLICATIONS

This application claims the benefit of U.S. Provisional Application No. 60/561,916 filed 14 Apr. 2004.

### FIELD OF THE INVENTION

The present invention relates generally to injecting liquid fertilizer, such as liquid manure, into the ground, and specifically to a method and metering equipment for doing so while causing: low disturbance to the surface, low contamination of and damage to vegetation, and high absorption by the soil.

### BACKGROUND

Land application of liquid manure has been recognised as a cost-effective and sustainable practice for using manure. Comparable crop yields can be achieved when using liquid manure to replace chemical fertilisers. However, all stakeholders recognise that some adverse environmental impacts are associated with manure application, such as nutrient loss through volatilization, nuisance odour emissions, and runoff of phosphorus to surface water. Known techniques for manure application include:

1) Broadcasting

When broadcasting, a tank wagon, sprayer boom, or irrigation gun discharges manure slurry under pressure in a fan spreading or high-trajectory pattern, such that 100% of the ground surface is covered with manure, maximizing volatilization loss and odour emissions. In grassland (e.g. hay or other forage) applications, the “painting” of existing crops with liquid manure provides additional area having exposed manure, which aggravates the problem of volatilization loss and odour, in addition to contaminating the forage leading to potentially pathogenic activities not desirable for animal grazing.

2) Surface Banding

In an attempt to alleviate the problems associated with broadcasting, surface banding has been tried on both grassland and cropland. Using a dribble bar, manure is delivered near and above the surface of the ground by pouring it out at low pressure leaving less than 100% of the surface covered with bands of manure, but still suffering from substantial evaporation, volatilization, odour, and contamination of feed or crops.

3) Surface Incorporation

After manure has been delivered by broadcasting or surface banding, it may be better incorporated into the soil by a tillage operation (e.g. using discs, cultivator tines, sweeps, or harrows) to mix the manure with soil. Since manure is mixed with soil, less manure is exposed such that less volatilization and odour occurs, but the manure is often only partially covered with soil. Surface incorporation usually is not an option for cropland where the tillage action would damage the crop stands.

4) Injection

Manure has also been delivered below the surface of the soil to minimise volatilization losses, odour, and runoff pollution—simultaneously providing more nutrients to plants. Conventional manure injection has been performed using high soil disturbance tillage tools, such as: discs, knives, openers, chisels, shovels, or sweeps. Disadvantageously, plant damage reducing yield, limits the applicability of such operations. Further, the high power requirement associated with soil cutting consumes large amounts of fuel, which adversely affects the economics of the farming operation that it supports.

5) Aeration

Aerators (e.g. AerWay™) have also been used to incorporate liquid manure into grassland, during which operations aerators perforate the top 50 to 150 mm of soil (without significantly damaging the crop), into which perforations manure is conventionally delivered by broadcast or banding. Disadvantageously, although part of the manure eventually runs into the perforations, the delivery of the fertilizing fluids above the surface still results in significant volatilization loss, odour, and contamination, such that this method is not classified as “injection” by regulatory bodies.

Examples of known technology include that taught in European patent application 94200180.1, which describes a device for injecting liquid manure into the ground using a “tillage means” having teeth or “protrusions” of a pointed, pyramidal, or conical design that create a plurality of aligned “depressions” much like the indentations of an aerator. A “manure feed means” including an outlet then pours or drizzles liquid manure in proximity above the resulting line of indentations in the ground. Disadvantageously, the indiscriminate delivery of manure slurry continuously along the line formed by the depressions results in significant contamination since the manure is not just deposited within the openings, but rather spills over onto both the forage and the surface of the ground between adjacent depressions. Further, the depressions are created by compressing rather than cutting an opening in the soil such that the compressed soil of the surface area inside each depression is less permeable to absorb liquids, resulting in the manure soaking into the surrounding soil at a slower rate.

U.S. Pat. No. 6,142,084 issued to Hatlo on 7 Nov. 2000, describes equipment for periodically injecting a concentrated jet of manure slurry under pressure sufficient that the jet bores its own “groove” or elongate cavity in the soil. A shoe including a breaker element is used to interrupt the jet in order to avoid creating a continuous opening in the soil. According to an alternate embodiment, the shoe also serves to close the groove after each injection cycle is complete. Disadvantageously, the system of Hatlo relies on significant and stable pump pressure in order to bore down to a consistent penetration depth, which choice of a complex sub-assembly leads to the need for substantial maintenance of the system. Further, the shoe element dragged along the ground tends to disturb forage by flattening anything along each of a series of continuous paths.

Environmental regulations increasingly require that producers apply manure on agricultural land as fertilizer in an environmentally friendly fashion, and in some cases it has been specifically regulated that liquid manure be injected, such that it is desirable to identify a technique and equipment useful to efficiently deliver liquid fertilizers, in properly metered amounts, below the surface of low compaction soil permitting with a high rate of absorption, but without erosion-promoting soil-disturbance or either severely damaging planted crops or contaminating forage present on the surface.

### SUMMARY OF THE INVENTION

In a first aspect of the invention, there is provided a method for dispensing liquid fertilizer directly into one or more sub-surface cavities in a region of crop or forage ground having a soil surface, the one or more cavities each having an opening at the soil surface, the method comprising the steps: locating a cavity; estimating the fluid capacity of the cavity; calculating dispensing parameters for delivery of liquid fertilizer into the cavity; and delivering to the cavity a volume of liquid fertilizer approximately equal to the fluid capacity of the cavity in accordance with said dispensing parameters.

The method may further comprise the step of cutting at least one sub-surface cavity into the ground prior to or in lieu of the step of locating a cavity.

In a further embodiment, the step of estimating the fluid capacity of the cavity comprises estimating the volume of the cavity and estimating the hydraulic conductivity of the soil surrounding the cavity.

In a further embodiment, the liquid fertilizer is dispensed from a moving platform, and the dispensing parameters may be preset or may be continuously adjusted, the parameters may include fertilizer flow rate, fertilizer viscosity, dispensing temperature, dispensing pressure, and height of dispensation above the soil surface.

In a second aspect of the invention, there is provided a soil-cutting apparatus for creating a sub-surface cavity while minimizing compaction of soil surrounding the cavity, wherein the cutting apparatus includes at least one cutting blade for slicing into the soil surface to create an opening at the soil surface and a cavity below the level of the soil surface.

In an embodiment, each cutting blade comprises a plate member anchored to the cutting apparatus, the plate member having a free cutting edge for slicing through soil, and the cutting edge may be profiled, having a curved or parabolic profile.

In a further embodiment, the cutting apparatus includes a plurality of cutting blades mounted on at least one cutting wheel coupled to at least one axle for rotation thereabout. The cutting apparatus may be raised or lowered based on the desired volume and depth of each cavity to be created.

In a further embodiment, the apparatus is coupled to a liquid fertilizer dispensing system such that each cavity may be filled with liquid fertilizer as it is created.

In a third aspect, there is provided a dispensing system for delivering liquid fertilizer to at least one soil sub-surface cavity having an opening at the soil surface, the system including at least one metering valve assembly for controlling the dispensing of fertilizer through any suitable injection device such that the fluid volume of liquid fertilizer dispensed corresponds to the fluid capacity of the cavity so as to avoid or minimize overflow onto the soil surface surrounding each opening.

In an embodiment, the fluid capacity of the cavity is determined by estimating the volume of the cavity and estimating the hydraulic conductivity of soil surrounding the cavity.

In a further embodiment, liquid fertilizer is delivered to a plurality of cavities in a region of crop or forage ground using a mobile platform comprising a liquid fertilizer tank having at least one dispensing nozzle.

In a further embodiment, the dispensing system may be associated with the above-described cutting system for cutting sub-surface cavities. If so associated, the metering valve assembly may be synchronized with the soil-cutting apparatus in order to dispense fertilizer into the cavities shortly after they are created. The synchronization may be accomplished using interacting mechanical gears or sprocket and chain assemblies; or any suitable location sensor and position control technology to locate cavities and direct the dispensing of liquid fertilizer. The location sensing may be accomplished by depth sonar, EMF proximity, laser, or light reflection technology.

In an embodiment, the metering valve assembly is adjustable in accordance with the effective momentary fluid capacity of the cavities, and may include a programmable control system to automatically adjust each metering valve assembly.

In a further embodiment, the injection device of the dispensing system is coupled to and integrated with the soil-cutting apparatus such that liquid fertilizer is simultaneously delivered to a cavity through the cutting blade creating the cavity while the cavity is created.

In a fourth aspect of the invention, there is provided an apparatus for applying liquid fertilizer to a region of crop or forage ground having a soil surface, the apparatus including a mobile platform for travelling over a region of crop or forage ground; a soil-cutting apparatus operably attached to the mobile platform, the soil-cutting apparatus including at least one cutting blade for slicing into the soil surface to create an opening at the soil surface and a cavity under the soil surface, while minimizing compaction of soil surrounding the cavity; a liquid fertilizer dispenser associated with the soil-cutting apparatus, the dispenser including at least one metering valve assembly for controlling the dispensation of fertilizer through at least one associated injection device; and a synchronization system for associating the metered fluid volume of liquid fertilizer dispensed with the location and size of each cavity; wherein as the mobile platform travels over the soil surface of the ground, cavities are created by the soil-cutting apparatus, and liquid fertilizer is delivered directly to each cavity by the dispensing system as determined by the synchronization system, in an amount less than or equal to the fluid capacity of each cavity so as to minimize overflow onto the soil surface surrounding each opening.

The accompanying drawings, which are incorporated and which constitute a part of this specification, illustrate preferred embodiments of the method, system, and apparatus according to the invention and, together with the description, serve to explain the principles of the invention.

### BRIEF DESCRIPTION OF THE DRAWINGS

The present invention, in order to be easily understood and practised, is set out in the following non-limiting examples shown in the accompanying drawings, in which:

FIG. 1 is a schematic side view of a liquid fertilizer injection system in use;

FIG. 2 is a perspective view of a soil cutting apparatus connected to a metering valve assembly;

FIG. 3 is a side view of a soil cutting apparatus with a drive sub-assembly;

FIG. 4 is a perspective view of a soil cutting apparatus having 6 cutting wheels;

FIG. 5 is an exploded perspective view of a metering valve assembly;

FIG. 6 includes left and right perspective views of a metering valve connected to 2 injector tubes;

FIG. 7 is a perspective view of a drive sprocket sub-assembly; and,

FIG. 8 is a rendering in perspective view of the liquid fertilizer dispensing system of the invention in towed position behind a liquid manure tank.

### DETAILED DESCRIPTION OF THE PREFERRED EMBODIMENT

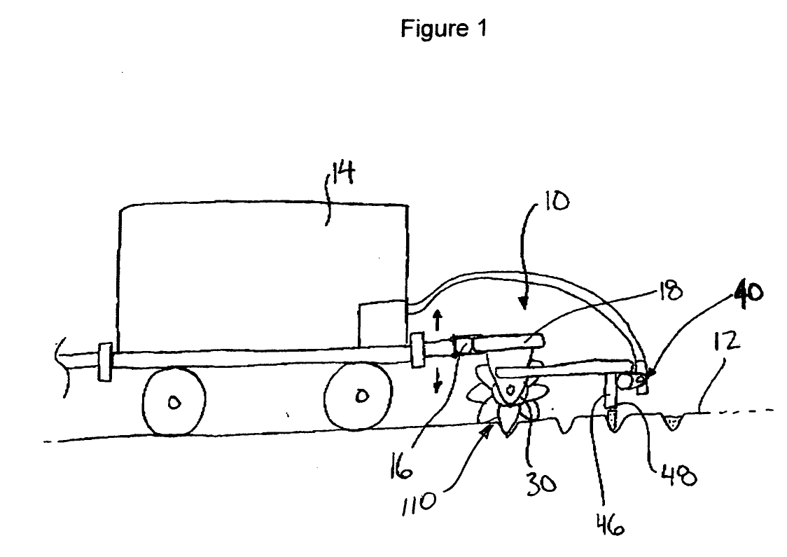

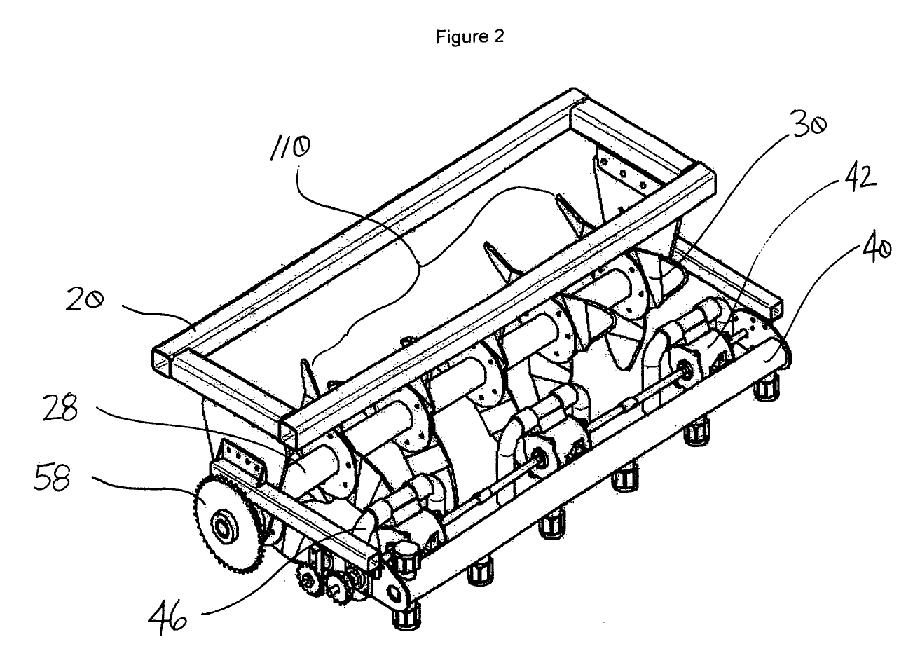

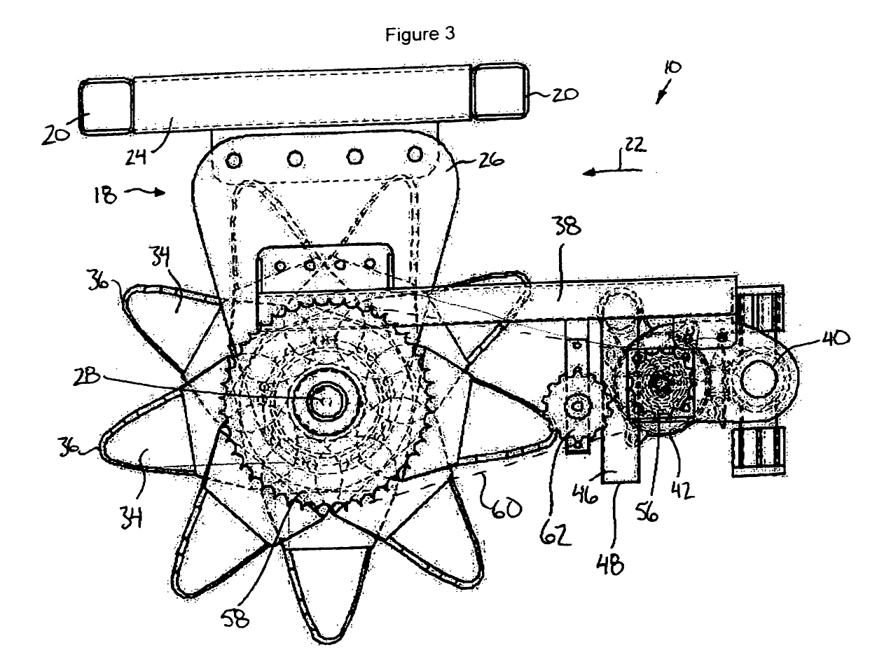

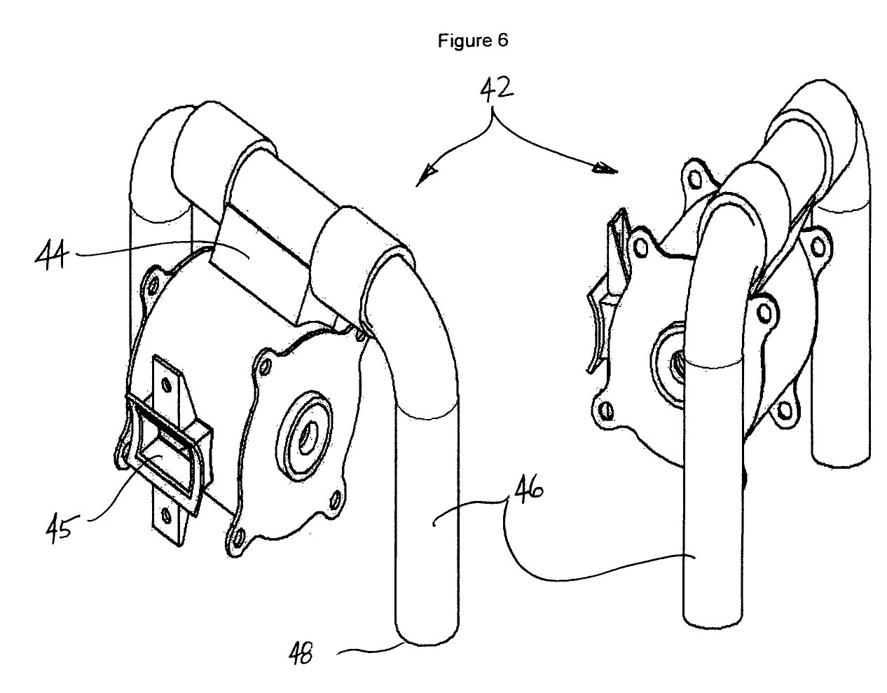

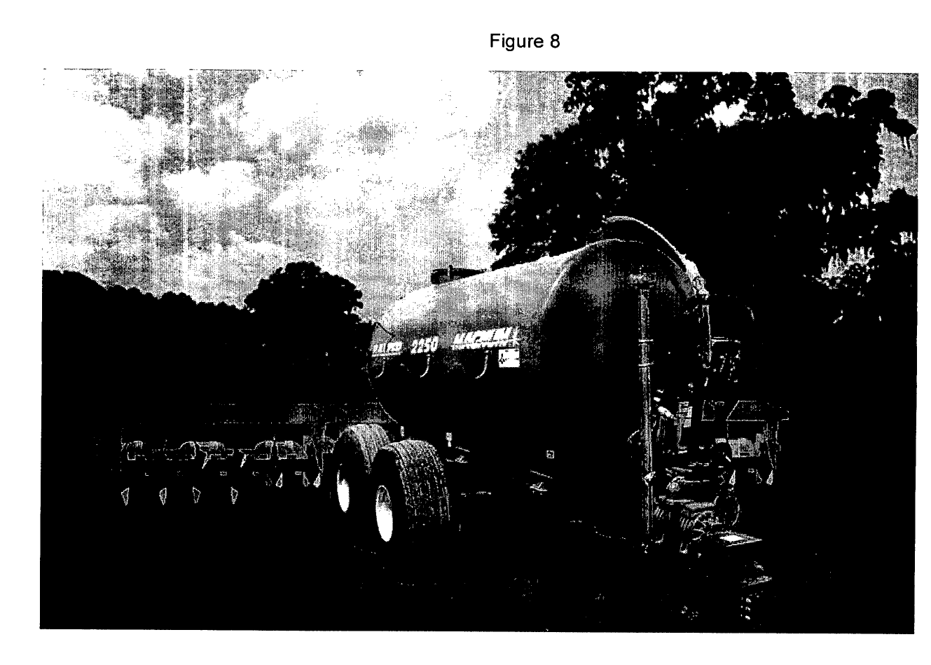

Referring to FIGS. 1 through 8 there is depicted one embodiment, denoted generally as 10, of the system of the invention for the controlled flow injection of liquid fertilizer into ground 12 (any appropriate crop or forage land). A source 14 (e.g. a tank) of liquid fertilizer supplies manifold 40 through at least one flow metering valve 42 (details seen in FIG. 6), sometimes referred to as a “pulsing valve assembly”, for periodically dispensing a definable volume of liquid. System 10 is typically located behind a source 14 (on any suitable moving platform) and supported for rolling movement along ground 12 behind a towing vehicle (not shown). Draw bar 16 as shown provides for height adjustment of system 10 in relation to ground 12. System 10 uses frame 18 to support soil cutting assembly 110 (wheels 30 on shaft 28 as defined in more detail below) that when towed across ground 12 cuts a plurality of low-compaction, spaced openings that may subsequently be filled with metered amounts of liquid manure.

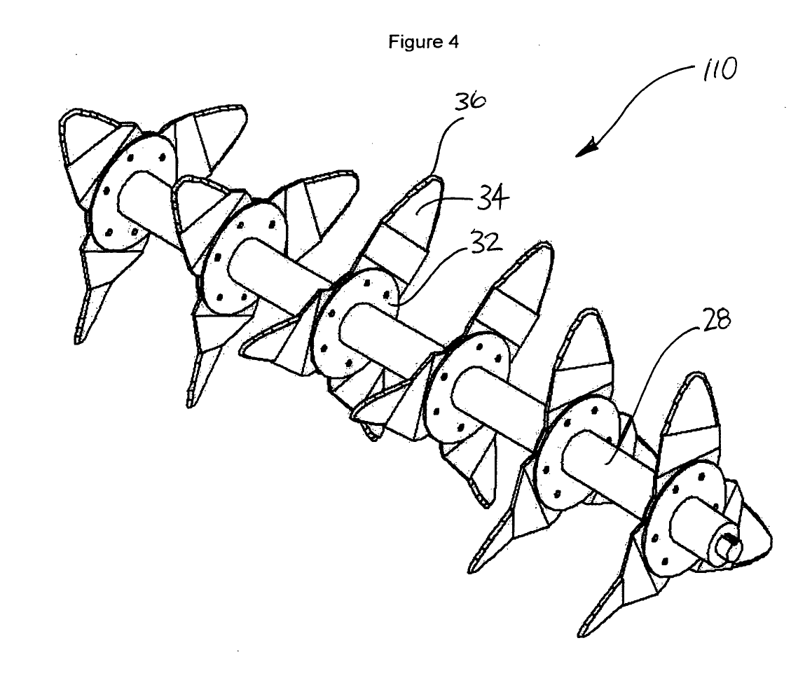

According to one embodiment of system 10, frame 18 includes beams 20 oriented substantially parallel and spaced from one another above the ground, and substantially perpendicular to a forward working direction 22 of system 10. Cross bars 24 are connected at each end of frame 18 between beams 20. Side members 26 are mounted at each end of frame 18 forming plates extending downwardly therefrom parallel to working direction 22 for carrying a wheel shaft 28 spanning therebetween. Shaft 28 is rotatably supported in relation to frame 18 by any suitable bearings and other hardware. A plurality of wheels 30 are mounted at spaced intervals along shaft 28 (forming soil cutting assembly 110 as seen in FIG. 4) in fixed orientation relative to shaft 28 for rotation therewith as shaft 28 rolls above ground 12. Each wheel 30 comprises an annular collar 32 fixed on shaft 28 using any suitable means for fastening a plurality of radially extending blades 34 protruding from each collar 32. Each protruding blade 34 comprises a plate member that narrows as it extends radially outward from shaft 28. Blades 34 are typically evenly spaced around the circumference of shaft 28 and each plate member is angled at an inclination of approximately 20° in relation to a vertical plane perpendicular to the axis of shaft 28. The outer end of each blade 34 is curved in profile so as to be substantially parabolic adjacent its apex 36. The purpose of combining these features is to cause soil cutting assembly 110 to slice (rather than compressing as would a blunt object) into ground 12 in order to create somewhat oblong openings—without excessively compacting the soil forming the walls (not shown) of each cavity through which liquid fertilizer must pass as it is absorbed by ground 12. Rails 38 are supported on frame 18 to extend rearwardly from inside members 26 generally horizontally spaced above ground 12. Rails 38 are spaced below the beams of frame 18 near shaft 28 for supporting manifold 40 spanning the rear free ends of rails 38. Manifold 40 comprises a hollow tube oriented perpendicular to working direction 22. Conduits (e.g. hoses, not shown) communicate with source 14 for connection to at least one position along manifold 40 supplying liquid fertilizer evenly to metering valves 42.

Advantageously, soil cutting assembly 110 includes a plurality of sharp edged blades 34 (having a curved or somewhat arched top view while also being substantially parabolic from a side view) designed to cut soil rather than dig into or rip up the surface of ground 12. In that respect soil cutting assembly 110 acts more like an aerator than a conventional tillage tool. The purpose of slicing open the surface (rather than compressing a small area to create a hole) is to relatively gently part the soil sideways without compacting the bottom of the resulting cavity in order that the porosity (permeability) of the soil at the bottom of the cavity is relatively undisturbed and the hydraulic conductivity of the region being fertilized is not reduced by the creation of the openings. Further, it is the objective of soil cutting assembly 110 to create a plurality of openings each leading to a low-compaction cavity having a proportionately large internal surface area through which to absorb liquids dispensed therein. By removing a small divot of soil in the course of opening the surface and separating the soil to sides that form a cavity, the exposed sub-surface soil of the internal walls of the cavity provide a larger porous surface through which liquids may be absorbed to feed adjacent roots. The slicing action of blades 34 also limits disturbance to plants adjacent the opening.

According to one embodiment of system 10, each wheel 30 includes three blades 34, such that each wheel 30 creates three openings per rotation, which may optionally be offset relative to openings created by the two wheels immediately adjacent along shaft 28. Sets of wheels may be oriented at even angular offsets about their axis of rotation so that only one set of blades penetrates the ground at any given time.

At least one metering valve 42 is associated with each wheel 30 at evenly spaced positions along manifold 40, however one metering valve 42 may also supply more than one wheel 30. Each metering valve 42 includes a cylindrical body having an inlet 45 to fluidly communicate with supply manifold 40 and an outlet 44 to fluidly communicate with dispensing injector tubes 46. According to one embodiment of system 10, each metering valve 42 includes a pair of injection tubes 46 such that one tube is provided for each wheel 30 of the set being supplied. Tubes 46 extend downward to near ground 12. A bottom open end 48 (to which any suitable flow controlling nozzle—not shown—may be attached) of each tube is positioned adjacent ground 12 when in use.

According to a preferred embodiment of system 10, soil conditions (e.g. measurements of current local hydraulic conductivity or permeability) are taken into account prior to fertilizing the region of land in question, and the fluid capacity of the cavities is estimated. Estimating the total fluid capacity of the cavities permits setting each metering valve 42 to release more or less liquid fertilizer into cavities that have been created by the soil cutting assembly 10. For example, if it is determined that the soil surrounding the cavity, based on the hydraulic conductivity of the soil in the region, is able to quickly absorb additional volumes of liquid fertilizer, then an amount of liquid fertilizer may be dispensed into the cavity which is greater than the actual volume of the cavity, while minimizing overflow onto the surrounding soil. A person of skill in soil fertilization would understand that by raising or lowering soil cutting assembly 110 relative to ground 12, both opening size and cavity depth will be smaller or larger respectively, which will (like soil conditions) influence the effective momentary fluid capacity of the resulting cavities for a given fluidity of the manure slurry comprising the liquid fertilizer. Other factors such as platform velocity and dispensation rate will affect the volume of the liquid that may be discharged by metering valve 42 into a cavity of known dimensions, without overflow onto the surface and plants surrounding the opening to the cavity being injected.

Various dispensing parameters, such as fertilizer flow rate, fertilizer viscosity, dispensing temperature, dispensing pressure, and height of dispensation above the soil surface, may be determined and preset or controlled during dispensation of fertilizer into the cavities. These parameters may be calculated and controlled during delivery by an automated system, or may simply be preset based on estimated optimal parameters.

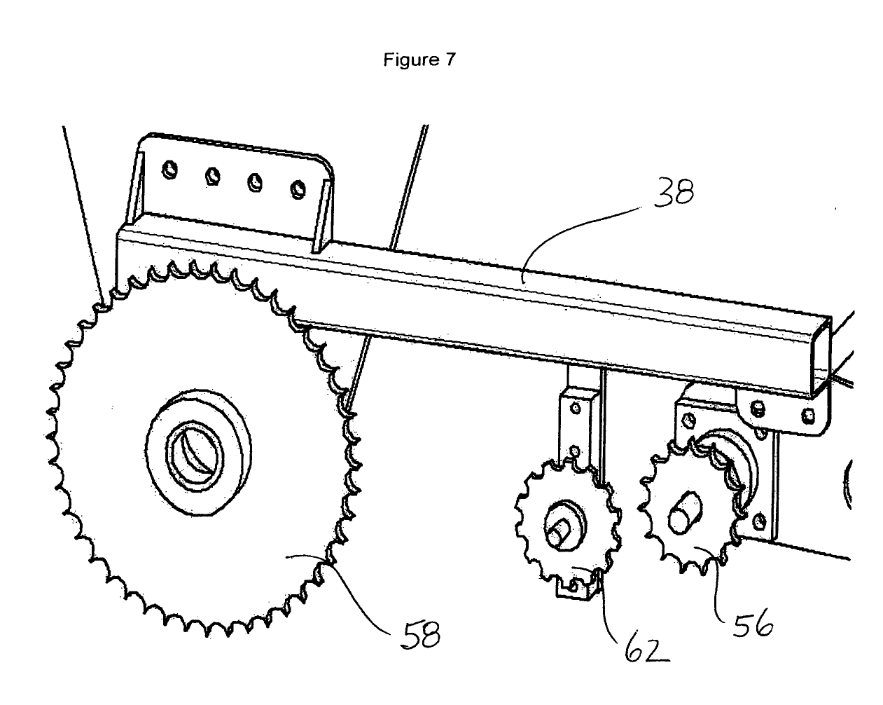

According to one embodiment of system 10, each metering valve 42 includes a rotating valve member within its cylindrical body. Each valve member 50 comprises any suitable sealing components supported for rotation about the axis of the cylindrical body and aligned along a common axis extending between metering valves 42 for supporting all rotating valve members 50 on a common valve shaft 52 that is formed in sections with couplings connecting adjacent sections. The openings at the inlet and outlet of each metering valve 42 are spaced by approximately 120°, while the openings between the free ends of the curved plate forming rotating valve member are approximately 230° apart so that both are open to the hollow interior of metering valve 42 over a small range of rotation of valve member, each of which are offset circumferentially by 120° from adjacent valve members when used with wheels 30 having three blades 34. Valve members are fixed on valve shaft 52 to synchronize rotation with wheel shaft 28 so that the timing of injection matches the openings being formed by wheels 30. As also seen in FIG. 7, a driven sprocket 56 is supported at one end of valve shaft 52 while a drive sprocket 58 is supported at the same end of wheel shaft 28 in which said sprockets are coupled to rotate together by any suitable drive chain 60. An idler sprocket 62 is provided for meshing engagement with chain 60 and supported on any suitable tightening mechanism for reducing slack in chain 60.

As described above, according to one of its embodiments, the system of the invention comprises cutting wheels (driven by contact with the ground) and synchronized metering valves, which together cut spaced openings in the ground and dispense controllable amounts of liquid fertilizer directly into associated sub-surface cavities through those openings. “Spoked” cutting wheels are mounted on a central shaft and each time a spoke reaches the ground it slices a substantially parabolic shaped opening in the ground. The wheel spacing along the central shaft and the spoke spacing on each wheel are designed in such a way that the openings in the ground are approximately 1 foot away from any other openings. If each pair of spoke wheels slice the ground at the same time, a single metering valve can reliably supply liquid manure for two wheels. The time that fertilizer is dispensed by the valve compared to when the cutter contacts the ground may be controlled by the chain drive, and it can be modified by simply changing the orientation of the sprockets in relation to each other prior to the chain being attached. On a system having 3 cutters per wheel, to produce one rotation of the metering valve per impact of the cutters with the ground, the valve is geared to rotate 3 times faster than the cutting wheel shaft 28.

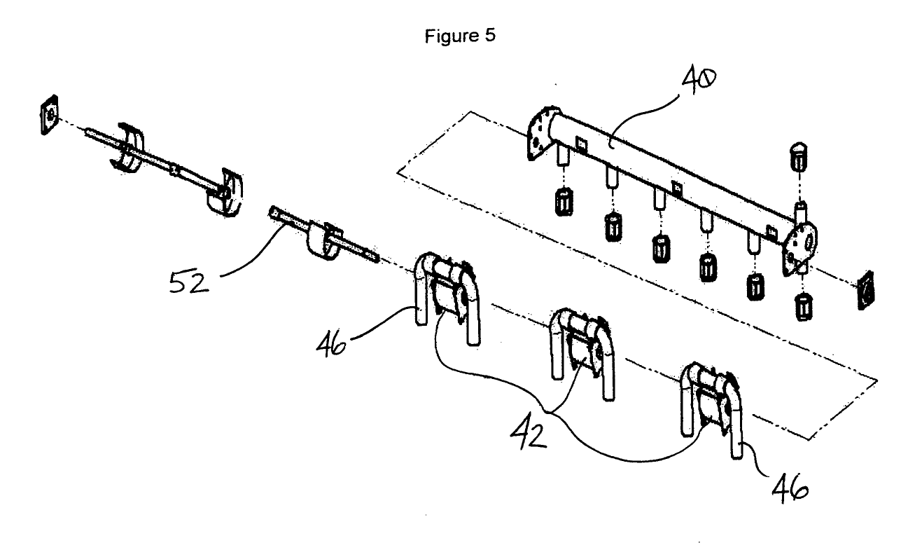

Using any form of valve to meter doses of liquid manure into cavities created by the cutting wheels is novel, but a person of skill in soil fertilization machines would understand that a wide range of valves may be applied to this new use. As seen in FIG. 5, one layout of such metering valves is a simple row of rotary valves mounted on a suitably sized (e.g. 89 mm diameter on the prototype) horizontal tube substantially perpendicular to the direction of travel of the system. Advantageously, this horizontal tube acts as both a support for the valves and a manifold supplying manure to those same valves. Mounting the tube behind the wheels allows the valves to be closer to the ground and spaced from the cutting wheels. Each valve can supply the required volume of liquid manure to two adjacent openings simultaneously. The injectors connected to the metering valve outlet are typically mounted so as to either avoid or allow them to absorb any impacts from surface obstacles such as clumps of soil, sticks, or stone on the ground. The bodies of the metering valves may be any suitable size (e.g. 125 mm diameter) and inside the valve body, an interior tube is attached to a drive shaft that extends out through both sides of the body. The interior tube is designed to cover the opening in the valve body through 230 degrees of its rotation and allow fluid to flow into the valve during the other 130 degrees of its rotation. In this way the valve can control the time that liquid manure is allowed past it in order to place the liquid manure into the cavities as the injectors pass over the openings in the ground.

Alternatively, the metered flow of liquid fertilizer may be delivered directly through each cutting head while creating a cavity, rather than by a separate dispensing sub-assembly trailing the soil cutting assembly.

Various additional methods of synchronizing cavity cutting with liquid manure injection are suitable for use in accordance with the invention. In the embodiment described above, the synchronization of the metering valve assembly with the soil cutting assembly is be achieved by interacting mechanical gears or sprocket & chain assemblies. However, the targeting of the delivery of the required volume of fluid may instead be accomplished using any suitable location sensor and position control technologies (e.g. depth sonar, EMF proximity, laser or light reflection) to locate cavities and direct streams of liquid fertilizer thereto.

The major application of the system of the invention is to inject liquid manure in forage fields. Another application is injecting manure in no-tillage systems that require low disturbance field equipment to maintain most of the residue cover on the soil surface. The system of the invention is suitable for liquid manure injection in spring. The ideal time for land application of liquid manure is after fall harvest. However, many producers need to apply manure in both spring and fall, due to the limited capacity of their manure storage facilities. Spring injection of liquid manure has proven very problematic to crop producers to the point of neighbours refusing “free” manure if it is to be injected in the spring. First, breaking the ground when injecting causes losses of soil moisture, which is quite detrimental in dry areas. Second, seedbeds are destroyed when injecting, as the conventional injectors break the ground and leave a very rough seedbed. The system of the invention may also be used with annual crop systems and the low power requirement of the system will be attractive to producers using those systems.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

Although the disclosure describes and illustrates various embodiments of the invention, it is to be understood that the invention is not limited to these particular embodiments. Many variations and modifications will now occur to those skilled in the art of liquid fertilizer application. For full definition of the scope of the invention, reference is to be made to the appended claims.

1. A method for dispensing liquid fertilizer directly into one or more sub-surface cavities in a region of crop or forage ground having a soil surface, the one or more cavities each having an opening at the soil surface, the method comprising the steps:
a) locating a cavity;
b) estimating the fluid capacity of the cavity;
c) calculating dispensing parameters for delivery of liquid fertilizer into the cavity; and
d) delivering to the cavity a volume of liquid fertilizer approximately equal to the fluid capacity of the cavity in accordance with said dispensing parameters.

2. The method of claim 1 wherein the step of estimating the fluid capacity of the cavity comprises estimating the volume of the cavity and estimating the hydraulic conductivity of the soil surrounding the cavity.

3. The method of claim 1 or 2 further comprising the step of cutting at least one sub-surface cavity into the ground prior to or in lieu of step a).

4. The method of any of claims 1 to 3 wherein the liquid fertilizer is dispensed from a moving platform.

5. The method of any of claims 1 through 4 wherein the dispensing parameters include any one of or a combination of: fertilizer flow rate, fertilizer viscosity, dispensing temperature, dispensing pressure, and height of dispensation above the soil surface.

6. A soil-cutting apparatus for creating a sub-surface cavity while minimizing compaction of soil surrounding the cavity, wherein the cutting apparatus includes at least one cutting blade for slicing into the soil surface to create an opening at the soil surface and a cavity below the level of the soil surface.

7. The apparatus of claim 6 wherein each cutting blade comprises a plate member anchored to the cutting apparatus, the plate member having a free cutting edge for slicing through soil.

8. The apparatus of claim 7 wherein the free cutting edge is curved in profile.

9. The apparatus of claim 7 wherein the free cutting edge is parabolic in profile.

10. The apparatus of any one of claims 6 through 9, wherein the cutting apparatus includes a plurality of cutting blades mounted on at least one cutting wheel coupled to at least one axle for rotation thereabout.

11. The apparatus of claim 6, wherein the apparatus may be raised or lowered based on the desired volume of each cavity to be created.

12. The apparatus of claim 6 wherein the apparatus is coupled to a liquid fertilizer dispensing system such that each cavity may be filled with liquid fertilizer as it is created.

13. A dispensing system for delivering liquid fertilizer to at least one soil sub-surface cavity having an opening at the soil surface, the system including at least one metering valve assembly for controlling the dispensing of fertilizer through any suitable injection device such that the fluid volume of liquid fertilizer dispensed corresponds to the fluid capacity of the cavity so as to avoid or minimize overflow onto the soil surface surrounding each opening.

14. The system of claim 13 wherein the fluid capacity of the cavity is determined by estimating the volume of the cavity and estimating the hydraulic conductivity of soil surrounding the cavity.

15. The system of claim 13 wherein liquid fertilizer is delivered to a plurality of cavities in a region of crop or forage ground using a mobile platform comprising a liquid fertilizer tank having at least one dispensing nozzle.

16. The dispensing system of any one of claims 13 through 15 further comprising the soil-cutting apparatus of claim 6 for cutting sub-surface cavities, wherein the metering valve assembly is synchronized with the soil-cutting apparatus in order to dispense fertilizer into the cavities shortly after they are created.

17. The system of claim 16 wherein the means for synchronizing the metering valve assembly with the soil-cutting apparatus uses interacting mechanical gears or sprocket and chain assemblies.

18. The system of claim 16 wherein the means for synchronizing the metering valve assembly with the soil-cutting apparatus uses any suitable location sensor and position control technology to locate cavities and direct the dispensing of liquid fertilizer.

19. The system of claim 18 wherein the location sensor is based on one of: depth sonar, EMF proximity, laser, or light reflection technology.

20. The fertilizer dispensing system of any one of claims 13 through 19 wherein each metering valve assembly is adjustable in accordance with the effective momentary fluid capacity of the cavities.

21. The system of claim 20, further comprising a programmable control system to automatically adjust each metering valve assembly.

22. The system of claim 16 wherein the injection device of the dispensing system is coupled to and integrated with the soil-cutting apparatus such that liquid fertilizer is simultaneously delivered to a cavity through the cutting blade creating the cavity while the cavity is created.

23. An apparatus for applying liquid fertilizer to a region of crop or forage ground having a soil surface, the apparatus including:
a mobile platform for travelling over a region of crop or forage ground;
a soil-cutting apparatus operably attached to the mobile platform, the soil-cutting apparatus including at least one cutting blade for slicing into the soil surface to create an opening at the soil surface and a cavity under the soil surface, while minimizing compaction of soil surrounding the cavity;
a liquid fertilizer dispenser associated with the soil-cutting apparatus, the dispenser including at least one metering valve assembly for controlling the dispensation of fertilizer through at least one associated injection device; and
a synchronization system for associating the metered fluid volume of liquid fertilizer dispensed with the location and size of each cavity;
wherein as the mobile platform travels over the soil surface of the ground, cavities are created by the soil-cutting apparatus, and liquid fertilizer is delivered directly to each cavity by the dispensing system as determined by the synchronization system, in an amount less than or equal to the fluid capacity of each cavity so as to minimize overflow onto the soil surface surrounding each opening.
